(19) United States
(12) Patent Application Publication
(10) Pub. No.: US 2013/0041499 A1
(43) Pub. Date: Feb. 14, 2013

(54) DEVICE AND METHOD OF MONITORING APPARATUSES FOR LIFTING VEHICLES

(71) Applicant: Giorgio Simonetti, Firenze (IT)

(72) Inventor: Giorgio Simonetti, Firenze (IT)

(21) Appl. No.: 13/640,937

(22) PCT Filed: Apr. 13, 2010
(86) PCT No.: PCT/IT2010/000152

§ 371 Date: Oct. 12, 2012

(51) Int. Cl. B66F 17/00; F16P 7/02; B66F 3/46; G06F 11/30

(52) U.S. Cl. 700/213

(57) ABSTRACT

A monitoring method and device for vehicle lifters of vertical type, said method and said device being particularly adapted to ensure keeping the load levelling in said lifters. Moreover, the device object of the present invention is such as to comprise all functionalities and controls object of the certification pertaining to the standard which regulates the maximum admissible unevenness when lifting. This allows to simplify the certification procedures, indeed limiting them to the device object of the present invention rather than to the whole vehicle lifter.

### FIELD OF THE INVENTION

The present invention relates to the field of lifting systems and apparatuses used in the industrial field. In particular, the present invention relates to the field of vehicle lifting systems.

### STATE OF THE ART

In the field of load lifters, in particular in the field of vehicle lifters, particular importance is given to lifters which have contact points with the load and are not mechanically bound with one another, which are normally referred to as vertical lifters.

These lifters permit to adapt to the various lifting conditions and needs such as for example arranging the load gripping points at different heights, the variable length and/or width of the load, the unevenness of the ground, etc.

With respect to such a versatility, said lifters should however ensure keeping the load levelling—i.e. keeping the reciprocal height of the gripping points—during all lifting steps. In other words, when lifting, all gripping points should keep the same distances from their respective gripping points in contact with the load.

To this end, a specific standard was promulgated which establishes the maximum admissible unevenness when lifting. These limits are currently set at 5 cm or 1°.

Therefore the need is not only for manufacturers to comply with the aforesaid limits but also to certify their product with respect to such a standard.

The object of the present invention solves the technical problem of providing a device for monitoring lifting systems, in particular for lifters of vertical type for railway vehicles, adapted to ensure keeping the load levelling as above. Moreover, the device object of the present invention is such as to comprise all the functionalities and controls including in the certification pertaining to the standard which regulates the maximum admissible unevenness when lifting. This allows to simplify the certification procedures, indeed limiting them to the device object of the present invention.

### BRIEF DESCRIPTION OF THE DRAWINGS

FIG. 1. Diagram of a vertical vehicle lifter associated with the load to be lifted.

FIG. 2. Diagram of a lifting arm of a vertical vehicle lifter.

FIG. 3. Diagram of a control station of a vertical vehicle lifter.

FIG. 4. Block diagram of the device according to the present invention.

FIG. 5. Block diagram of a preferred embodiment of the output section of the device according to the present invention.

### SUMMARY OF THE INVENTION

The object of the present invention relates to a method and device for monitoring vehicle lifters of vertical type, said method and said device being particularly adapted to ensure keeping the load levelling in said lifters.

### DETAILED DESCRIPTION OF THE INVENTION

FIG. 1 illustrates a vertical vehicle lifter. Lifters of this type generally comprise a plurality of lifting arms 10 and at least one control station 11 from where an operator can monitor the operations of the lifter.

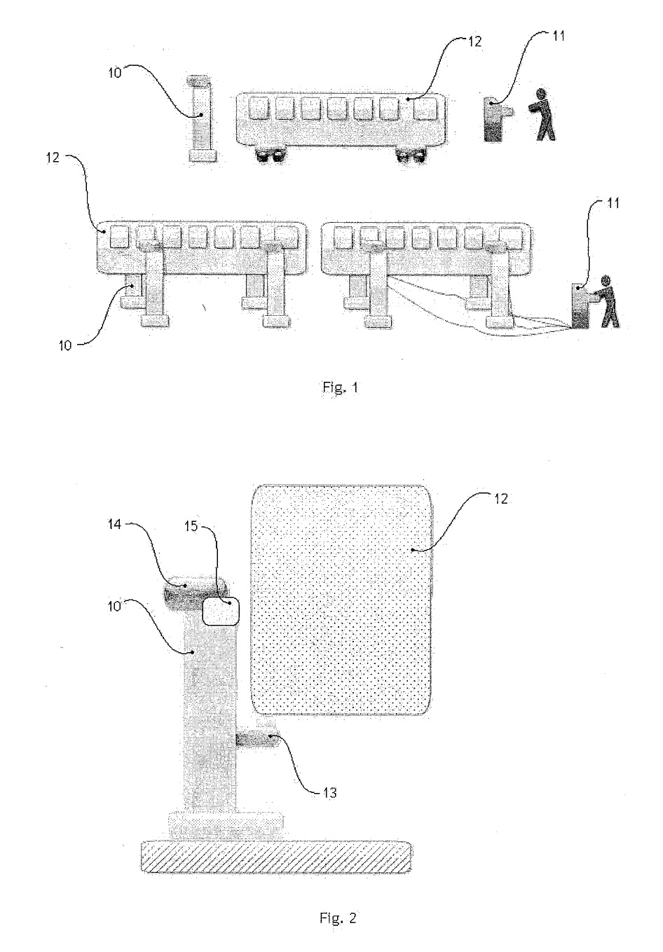

With reference to FIG. 2, arm 10 is the mechanical element by means of which the load is lifted, e.g. the railway vehicle 12 depicted in FIG. 1. A standard lifter generally comprises four arms arranged at specific load gripping points. Each arm comprises a loading bucket 13 comprising a movable element which is brought in contact with the load to be lifted, an electric motor 14 associated with said loading bucket 13, an encoder 15 for detecting the lifting height and a plurality of sensors adapted to determine the lifting parameters at every moment, such as for example the pressure on said buckets 13 so as to determine the grip in contact with the load to be lifted.

Said motor is preferably connected to said loading bucket by means of a gear motor and a system having a worm screw and nut.

With reference to FIG. 3, said control station 11 is the monitoring interface by means of which an operator can monitor the lifter. It comprises a user interface, preferably comprising in turn a display 20 and a keypad and a control button panel 25, a control module comprising in turn a power control module of the motors of arms 21, a user interface management module 22, a lifting logic management module 23 and a module for safely monitoring emergencies and levelling 24 comprising in turn the device according to the present invention.

The block diagram of the device according to the present invention is illustrated in The device object of the present invention comprises an input section 40 adapted to receive signals from the contact sensors and from the encoders 15 of the vertical lifter as well as from a plurality of emergency reporting contacts 16 or similar reporting devices, a processing section 41 having a redundant structure preferably based on at least two microprocessors 45, and an output section 42 adapted to enable or inhibit the operation of the motors of said vertical lifter. Said input section 40 comprises a plurality of input channels 43 adapted to receive signals from said vertical lifter and from a plurality of emergency reporting contacts 16 or similar reporting devices, said input channels being further connected to electrical decoupling stages and/or to amplifying stages 44 preferably comprising optical couplers and transistors, respectively. Said emergency reporting contacts 16 are preferably connected to emergency buttons conveniently located—e.g. close to each of said arms 10—so that the operator can readily stop the lifting while avoiding conditions of danger or of non-conformity for proper operation, and to reset buttons conveniently located so that the operator can restore the functionality of the lifter once said dangerous conditions have been removed. Said input channels are in such a number to provide a convenient degree of redundancy to reduce the probability that possible malfunctions thereof may jeopardize the proper operation of the whole system.

Said processing section 41 is adapted to read the signals from said lines and to interpret the information thereof to drive said output section 42 so as to enable or inhibit the operation of the motors of said vertical lifter. Said output section 42 preferably comprises a plurality of relays 46 conveniently connected so as to superintend the power supply of the motors of said vertical lifter in order to enable it or inhibit it.

Said relays 46 are employed according to a redundant scheme which, with reference to the preferred embodiment illustrated in FIG. 5, may comprise three relays 46 connected to three input lines associated with two emergency reporting contacts 16a and with a reset reporting contact 16b.

The device object of the present invention is not bound to a specific model of lifter or to a specific installation, but may be used on a wide range of lifters, in particular vertical lifters, for railway or street vehicles. In particular, each device according to the present invention may manage up to a maximum of six arms. Moreover, several devices object of the present invention may be cascade-connected to one another in order to monitor lifting trains comprising several cars. In particular, each device may be configured to monitor four gripping points with the load and also the unevenness related to one or two adjacent devices. Thereby, levelling of both the single car and the whole train consisting of several cars, is ensured.

The device object of the present invention is thus adapted to interface with pre-existing control circuits of vehicle lifters, in particular vehicle lifters of vertical type, so as to manage the safety functions thereof and the detection of emergency conditions, in particular in relation to the following aspects:
managing the emergency function and the emergency buttons;
managing the function of monitoring the levelling between the arms (e.g.
within the limits of +/−2.5 cm provided by Standard EN 1493), up to a maximum of six arms, with the possibility of interfacing several devices for managing multiple lifters in the case of trains having several cars;
managing the function of monitoring the gripping and keeping the contact of the arms.

The aforesaid management of the emergency function provides the immediate interruption of the power supply of all arm-lifting motors and of all the other possible actuators—such as for example the motors of the movable buckets—when at least one of the emergency buttons located on the lifter or in areas deemed critical, is activated.

The device according to the present invention manages the emergency logic by reading convenient input signals coming from the outside, from at least two separate and independent lines associated with said emergency reporting contacts. Said input signals are sent to the safety relays 46 of the output block of the device according to the present invention; said relays 46 are further connected to said processing module so as to permit the contacts of said relays 46 to be opened upon the occurrence of emergency conditions.

For example, the coils of said relays 46 may be connected to convenient outputs of said microprocessors.

The control logic implemented in said processing module provides for the emergency procedure being started by two separate logics:
pressing a button outside the card,
the card detecting an anomalous condition which could be dangerous.

In the case of pressing an emergency button, this results in the drop of power to the coils of said relays with a consequential forced entry into state of emergency.

The two microcontrollers of said processing module follow such an event and activate, in turn, the emergency signals.

Parallelly, the aforesaid management of the emergency function also provides the management of the reset logic, so that the emergency state remains active until one of the reset buttons is activated. So as to place the system back into normal operating conditions.

The aforesaid management of the levelling monitoring function between the load gripping points of the lifter arms provides supervising and monitoring the degree of levelling between the lifting system arms, operationally managed by the lifter control circuit in an autonomous manner, so that it remains within pre-established limits, e.g. those imposed by the Standard EN 1493 (+/−2.5 cm).

This monitoring occurs without interfering with the operation of the pre-existing control circuit of the vehicle lifter.

If the functionality of the lifter control unit does not correctly operate and the pre-set unevenness limit is reached, e.g. that provided by the standard cited, the device according to the present invention intervenes by directly acting on the above-described emergency circuit which provides to disconnect the power actuators 47 of the lifter.

Managing the levelling monitoring function between the arms occurs in two steps:
reading and validating the height;
calculating the levelling.

Reading and validating the height includes that a series of controls are actuated for each arm, which assess the plausibility of the value transmitted by the encoder associated with each lifter arm. Thereby, the device object of the present invention allows to carry out a check which is in any event able to confirm or refuse the height value received, regardless of the proper operation of the encoder. The step of reading and validating the height occurs as explained below.

First, the signals transmitted by the encoder are read. Normally, said signals are three in number: the height value in mm, the value provided by the analog sensor inside the encoder, and the value provided by the digital sensor inside the encoder.

Then, a number of valid messages received per second is monitored for each arm of the system.

The congruency of the analog and digital values is monitored, which values should have a minimum deviation within a certain threshold, e.g. +/−2 mm.

The plausibility of the height read is monitored in two steps: monitoring in the case of stopped arm and in the cases of ascending or descending moving arm.

Said plausibility monitoring of the height read is performed as follows, if the motor moves upwards, the height should correspondingly vary, i.e. by increasing its value at the expected speed; if the motor is controlled downward, the height should correspondingly vary at the right speed thus decreasing; if the motor is not controlled, the height should remain stable without variations.

Again with reference to FIG. 5, the step of calculating the levelling is carried out by the steps of calculating the maximum and minimum paths from the load gripping point and the levelling monitoring point.

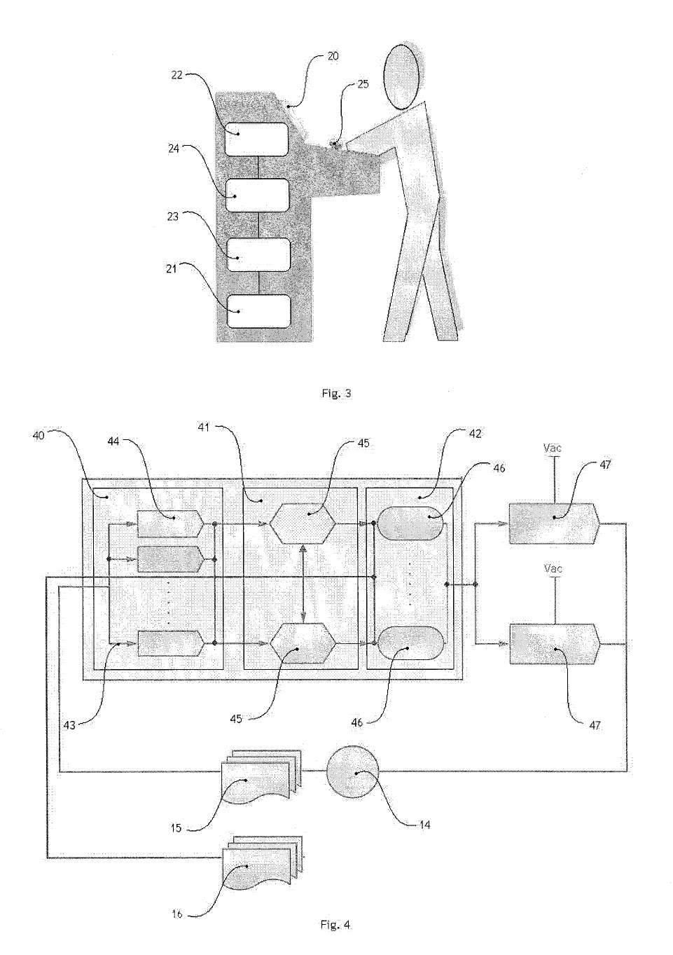

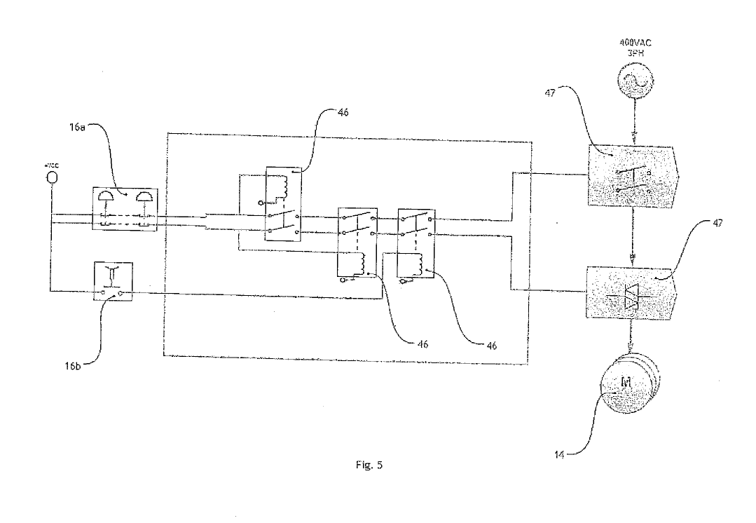

The vertical lifter is equipped with contact sensors with the body of the vehicle to be lifted. These sensors are normally housed in the movable arms and are of the “proximity sensor” type. Said sensors provide a positive electric voltage when the load on the gripping point exceeds a certain threshold (normally about 60 kg) and are used in all the load lifting steps: in-contact gripping, synchronized lifting, synchronized descent, detachment from the body and the levelling to zero. All the aforesaid load lifting steps are determined by the monitoring system of the vertical lifter and are monitored instant by instant by the device according to the present invention, to which the signals related to the aforesaid contact sensors arrive, preferably on two separate channels: a first channel provided with serial interface, for example of RS485 type, associated with the encoder and containing the information from the sensor, and a second channel directly from the sensor, as shown in FIG. 4.

The device according to the present invention intervenes by means of the emergency logic each time that the conditions encountered are not between the intervals of normal operation and therefore they may be indicative of a failure or human error. The device according to the present invention calculates the maximum and minimum paths from the load gripping point according to the following steps.

All the lifter arms are placed in contact with the load gripping points and the heights of each contact point are then stored. Such a storing permits to calculate the single “paths from contact” by means of which the correct load levelling kept may be assessed.

At this point, the levelling monitoring step is entered, where the calculation of the unevenness is carried out with respect to the in-contact gripping position; the comparison of the unevenness calculated at the preceding stage with an alarm value, e.g. +/−2.5 cm, is carried out and the emergency mode is activated in case of excessive unevenness.

1-15. (canceled)

16. A monitoring device for vehicle lifters of vertical type, adapted to ensure keeping and monitor the load levelling in said lifters, comprising an input section comprising a plurality of input channels adapted to receive signals from the contact sensors and from the encoders of said vertical lifter and from a plurality of emergency reporting contacts or similar reporting devices, a processing section associated with said input section and adapted to monitor the operation of said vertical lifter and to detect any anomalies thereof, and an output section associated with said processing section and adapted to enable or inhibit the operation of the motors of said vertical lifter according to the signals received from said input sections and said processing section characterized in that said output section comprises a plurality of relays conveniently connected and redundantly configured so as to monitor the power supply of the motors of said vertical lifter so as to enable or inhibit the operation thereof.

17. The device according to claim 16, wherein said processing section comprises a redundant structure preferably based on at least two microprocessors.

18. The device according to claim 16, wherein said input channels are further connected to electrical decoupling stages and/or to signal amplifying stages.

19. The device according to claim 16, wherein said emergency reporting contacts are preferably connected to emergency buttons located close to each of the arms of said lifter, and to reset buttons.

20. A method of monitoring vehicle lifters of vertical type, adapted to ensure keeping the load levelling and managing possible emergencies in said lifters, comprising the following steps:
a) reading the signals from said vertical lifter and from a plurality of emergency reporting contacts or similar reporting devices;
b) determining possible emergency conditions related to the read signals from at least one of the emergency buttons of said plurality of emergency reporting contacts or similar reporting devices;
c) managing the possible emergency conditions encountered at the preceding step b);
d) determining the possible emergency conditions related to the read signals from said vertical lifter;
e) managing the possible emergency conditions encountered at the preceding step;
f) cyclically repeating of the preceding steps from a) to e).
characterized in that said step c) is carried out through the following further steps: g) immediate interruption of the power supply of all arm lifting motors and of all other possible actuators of said vertical lifter; h) start of emergency operating mode; i) reading of the signals from said emergency reporting contacts and from the reset reporting contacts; j) management of the logic of resetting and restoring the normal operation.

21. The method according to claim 20, wherein said step d) comprises monitoring the levelling between the arms of said lifter by carrying out the following steps:
l) reading and validating the lifting height;
m) calculating the levelling between the load gripping points of the lifter arms.

22. The method according to claim 21, wherein said step 1) of reading and validating the lifting height comprises the following sequence of steps:
n) reading the signals transmitted by the encoder of said vertical lifter;
o) monitoring to ensure a number of valid messages is received in the time unit for each arm of the system;
p) monitoring the congruency of the analog and digital values read at step n), in order to establish that they have a minimum deviation within a certain threshold;
q) monitoring the plausibility of the read signals comprising two separate steps: monitoring in the case of stopped lifter arm and in the cases of ascending or descending moving arm;

23. The method according to claim 21, wherein said step m) of calculating the levelling between the lifter arms comprises the following sequence of steps:
r) calculating the maximum and minimum paths from the load gripping point;
s) step of monitoring the levelling by calculating the unevenness with respect to the in-contact gripping position by comparing the unevenness calculated in the preceding step with an alarm value, and activating the emergency mode in case of excessive unevenness.

24. The method according to claim 23, wherein said step r) comprises the following steps:
t) all lifter arms are placed in contact with the load gripping points;
u) the heights of each contact point are stored.
